(19) United States
(12) Patent Application Publication
(10) Pub. No.: US 2009/0213878 A9
(43) Pub. Date: Aug. 27, 2009

(54) Broad-Area Microlasers and Methods for Driving Them

(76) Inventors: Michael Peeters, Ternat (BE); Guy Verschaffelt, Antwerpen (BE); Hugo Thienpont, Halle (BE); Bart Wattyn, Dentergem (BE)

Correspondence Address: BACON & THOMAS, PLLC, 625 SLATERS LANE, FOURTH FLOOR, ALEXANDRIA, VA, 22314-1176, US

(21) Appl. No.: 11/794,719

(22) PCT Filed: Jan. 7, 2005
(86) PCT No.: PCT/BE05/00004

§ 371 Date: Nov. 8, 2007

(51) Int. Cl. H01S 3/098; H01S 3/10

(52) U.S. Cl. 372/19; 372/20

(57) ABSTRACT

A multi-mode microlaser and a method for driving a multi-mode broad-area microlaser such as a multi-mode VCSEL is described such that the multi-mode microlaser shows an unexpected Gaussian-like far-field intensity distribution. The driving conditions are in general determined such that a strong reduction of the degree of spatial coherence occurs. For square pulsed driving current, these conditions are determined by the pulse duration p_{d} and the pulse height pₕ. A Gaussian-like far-field intensity distribution is obtained for pulsed multi-mode broad area microlasers. The typical spatial coherence area corresponding with these driving conditions is substantially independent of the Fresnel number of the microlaser. Additionally, this partial spatial coherence can be tuned by changing the driving conditions, such as e.g. the pulse shape and length.

### TECHNICAL FIELD OF THE INVENTION

The present invention relates to microlasers and a method to drive microlasers. In particular, the invention relates to methods for optimising the far-field output of broad-area microlasers and microlasers used accordingly.

### BACKGROUND OF THE INVENTION

When light sources are used in an experiment or application, it is necessary to have a correct description of the emitted field. Furthermore, often a transverse beam profile according to specific requirements such as e.g. a Gaussian profile is preferred. The far field beam profile is determined by the near field amplitude, phase and the degree of spatial coherence of the beam. The degree of spatial coherence can be influenced in several ways. In order to obtain a beam with small spatial coherence, e.g. liquid crystals can be placed in a light beam, transmission filters or holographic filters can be applied, or sound waves can be used to disturb, scatter or diffuse the beam. The latter is described in more detail in “Optical Coherence and Quantum Optics” by Mandel and Wolf (Cambridge University Press 1995) as well as the advantages this approach and the resulting reduction of spatial coherence has in certain applications.

Vertical-cavity surface-emitting lasers, also called VCSELs, are well known and widely used optoelectronic components. A detailed description of the operation principles of VCSELs is given by T. E. Sale in “Vertical Cavity Surface Emitting Lasers, Optoelectronic series; 2” (John Wiley&Sons inc. 1995). By way of example, a simplified cross-sectional view of a conventional VCSEL structure is shown in FIG. 1. VCSEL 100 is fabricated on a semiconductor substrate 102, e.g. a gallium arsenide substrate. A first mirror region, typically a stack of distributed Bragg reflectors 104, comprised of a plurality of alternating layers is positioned on a surface 106 of semiconductor substrate 102. The plurality of alternating layers of the first stack of distributed Bragg reflectors may be formed of n-doped aluminum arsenide material and n-doped gallium aluminum arsenide material. There is next fabricated a cladding region 110 on a surface of the first stack of distributed Bragg reflectors 104, an active region 112 disposed on cladding region 110 and a cladding region 114 disposed on a surface of active region 112. A second mirror region, typically a stack of distributed Bragg reflectors 116 is positioned on a surface of cladding region 114. The second stack of distributed Bragg reflectors 116 is formed of a plurality of alternating layers, more specifically, for example, alternating layers of a p-doped aluminum arsenide and a p-doped gallium aluminum arsenide. The second stack of distributed Bragg reflectors 116 is followed by a p-doped (10¹⁹ cm⁻³ or higher) contacting layer 120, which may e.g. be a one-half wavelength aluminum gallium arsenide layer. An additional cap layer (not shown in FIG. 1) also may be provided. The active region 112 is typically constructed from one or more quantum wells of InGaAs, GaAs, AlGaAs, (AI)GaInP, GaInAsP or InAlGaAs, or is a bulk material active region. It should be noted that VCSEL 100 is not shown to scale in FIG. 1. In particular the mirror regions and active regions have been expanded to provide clarity in the drawing. In practice, the thickness of the substrate 102 is typically 150 μm compared to about 10 μm for the mirror and active regions. Current is supplied through the top contacting layer and a bottom contacting layer 122. Current confinement may be achieved by means of selective lateral oxidized layer 124, such as a layer formed by selective oxidation of an approximately 30 nm thick extra AlAs layer placed directly above the top cladding layer 114.

VCSELs with a small diameter, typically less than 6 micrometer, can be single transverse mode. Such single-mode VCSELs have, both in the near and far field, a Gaussian intensity profile over a transverse cross-section of the light beam. Although these single-mode VCSELs have a suitable beam profile for many applications, the maximum obtainable optical power emitted in continuous wave driving mode is limited due to thermal effects. The latter can be improved by operating the VCSEL in pulsed driving mode, thereby reducing thermal effects. In this way, the obtainable peak optical output power can be substantially increased. In order to further increase the power obtainable from VCSELs, it is possible to increase the typical diameter of the emitting surface of the VCSEL past 6 micrometer, up to hundreds of micrometer. These devices are then no longer single-mode, but are called multi-mode, as the emitted light beam consists of multiple transverse modes as is clearly visible in the near and far field profiles. The multiple transverse modes are often approximated by the well known Laguerre-Gauss modes of circular waveguides. Typically, multi-mode VCSELs are used in continuous wave mode and allow to obtain a sufficiently high power for most common applications.

Nevertheless, whereas the single-mode VCSEL has a straightforward and very suitable beam profile, i.e. a Gaussian beam profile, the near and far-field beam profile of a large multi-mode VCSEL operated in continuous wave mode consist of multiple modes and are significantly more complicated. The description of the modal pattern in multi-mode VCSELs in continuous wave operation (CW) is difficult and therefore often looked at with a model for a limited number of modes, in order to reduce complexity. A number of studies have already shown that a large multimode VCSEL in CW operation can indeed show complex pattern formation. The latter is discussed in more detail by Huang et al. in Phys. Rev. Left. 89 (2002) 224102.

Experimentally influencing the light output of a multi-mode VCSEL by introducing additional intra-cavity elements is known, e.g. from U.S. Pat. 5,956,364. U.S. Pat. No. 5,956,364 describes a VCSEL which is adapted with a shaped cavity mirror, integrated in the second stack of distributed Bragg reflectors, in order to modify the light output of the VCSEL. The shaped cavity mirror acts as a random phase mask. The latter allows to obtain an output beam with a low coherence, which is advantageous for obtaining a homogeneous beam in multi-mode VCSELs. Nevertheless, U.S. Pat. No. 5,956,364 has the disadvantage that an additional intra-cavity element is needed to allow to influence the output beam of a VCSEL, thus requiring the need for adapting the VCSEL structure.

### SUMMARY OF THE INVENTION

It is an object of the present invention to provide improved microlasers and a method to drive microlasers. An advantage of the present invention is that it can provide a method for optimising the far-field output of broad-area microlasers as well as microlasers used accordingly. For example the present invention can provide broad-area microlasers and a method for driving broad-area microlasers which allows a more desirable beam profile in the far field, such as e.g. a Gaussian light beam profile.

The above objective is accomplished by a method according to the present invention. The invention relates to a method for driving a multi-mode broad area micro-laser, the method comprising, driving said micro-laser with an electric driving current, said driving current selected so as to obtain a reduced degree of spatial coherence transverse to said far field of said light beam from said multi-mode broad area micro-laser. Said light beam may be a laser beam. With a reduced degree of spatial coherence it is meant that the light beam is not completely coherent over its transverse profile. Light at two points within the transverse profile is considered to be coherent when the degree of coherence exceeds 0.88. Light at two points within the transverse profile is considered to be partially coherent if the degree of coherence is less than 0.88 but more than nearly zero. Light at two points within the transverse profile is considered to be incoherent if its degree of coherence is nearly zero or zero. The degree of coherence thereby is determined as the visibility V of the fringes of a two light beam interference test. This visibility is defined as (Iₘₐₓ−Iₘᵢₙ)/(Iₘₐₓ+Iₘᵢₙ), with Iₘₐₓ being the maximum intensity in the interference pattern and Iₘᵢₙ being a minimum intensity in the interference pattern. A reduced degree of spatial coherence may mean that the coherence area of the beam, which is the area of the beam cross-section wherein the light is coherent, well defined e.g. by Mandel and Wolf in “Optical Coherence and Quantum Optics” Wolf (Cambridge University Press 1995 ), is less than its aperture area. A reduced degree of spatial coherence of an illumination beam thus may be defined as an illumination beam having a coherence area smaller than the aperture area, more preferably smaller than one quarter the aperture area, even more preferably smaller than one tenth of the aperture area, still more preferably smaller than one hundredth of the aperture area, having as lower limit, where the microlaser becomes indistinguishable from an incoherent light source.

The method may comprise, for the micro-laser emitting at a resonant wavelength λ, a driving current I(t) being selected such that the change of resonant wavelength as a function of time t fulfils

$$\vert \frac{d }{d t} λ ( I ( t ) ) \vert > \frac{1}{10} \frac{pm}{µ s}$$

and the driving time t fulfils t>20 ns. Driving time t herein represents the time of actual driving, such as e.g. a pulse duration for a pulsed driving current. The driving current may be a rectangular current pulse having a pulse height pₕ and a
pulse duration p_{d} such that

$$\vert \frac{d }{d t} λ ( I ( {p}_{h} , {p}_{d} ) ) \vert > \frac{1}{10} \frac{pm}{µs}$$

and p_{d}>20 ns. The pulse duration p_{d} and said pulse height pₕ may be selected such that 0.1 μs<p_{d}<5000 μs and 30 mA<pₕ<500 mA. The selection of the driving current may be further restricted due to thermal conditions. The pulse duration may be in a range having a lower limit of 0.1 μs, preferably 0.5 μs, more preferably 1 μs still more preferably 2 μs and an upper limit of 5000 μs, preferably 1000 μs, more preferably 500 μs, still more preferably 100 μs and the pulse height pₕ being selected larger than 30 mA, preferably larger than 75 mA, more preferably larger than 100 mA. It is to be noted that the pulse height of the current needed for performing driving according to the present method will significantly depend on the design and growth conditions of the device driven. The driving current may be selected such that a contrast Co between interference fringes in a Young's experiment for at least part of the light in a far field of said light beam is smaller than a predetermined value A, i.e. Co<A. The contrast thereby may be defined as Co=|(Iₘₐₓ−Iₘᵢₙ)/(Iₘₐₓ+Iₘᵢₙ)|. It is to be noted that the contrast equals the visibility of the interference fringes, which equals the degree of coherence. Young's experiment may be performed using an interference mask comprising two apertures, being slits or pinholes. The apertures may be spaced apart by a distance of the order of magnitude of the diameter of the micro-laser. The distance may be between 1 and 10 times the diameter of the micro-laser. The apertures may have a size between 0.1 and 10 times the diameter of the micro-laser. The predetermined value A may be 0.88, preferably 0.5, more preferably 0.3, still more preferably 0.2. The multi-mode broad area micro-laser may be a multi-mode vertical cavity surface-emitting laser. The multi-mode broad area micro-laser may have an aperture with a characteristic diameter of more than 10 μm. The light output of said light beam having a reduced degree of spatial coherence may be used for any of microdensitometry, line width experiments, laser range finders or lithography applications.

The invention also relates to a method for tuning a light beam of a multi-mode broad area micro-laser, the method comprising driving during at least one first time period t₁ the multi-mode broad area microlaser with an electric driving current selected so as to obtain a reduced degree of spatial coherence in the far field plane transverse to said light beam from said multi-mode broad area micro-laser, in order to adjust a light output of said spatial only partial coherent light beam. With a reduced degree of spatial coherence it is meant that the light beam is not completely coherent over its transverse profile. Coherency or the degree of coherence thereby is determined as the visibility V of the fringes of a two light beam interference test. A reduced degree of spatial coherence may mean that the coherence area of the beam is less than its aperture area. A reduced degree of spatial coherence of an illumination beam thus may be defined as an illumination beam having a coherence area smaller than the aperture area, more preferably smaller than one quarter the aperture area, even more preferably smaller than one tenth of the aperture area, still more preferably smaller than one hundredth of the aperture area, having as lower limit, where the microlaser becomes indistinguishable from an incoherent light source. Said driving current I(t) may be such that the change of resonant wavelength as a function of time t fulfils

$$\vert \frac{d }{d t} λ ( I ( t ) ) \vert > \frac{1}{10} \frac{pm}{µs}$$

and the driving time t fulfils t>20 ns. Said driving current I(t) may be a rectangular current pulse and may have a pulse height pₕ and a pulse duration p_{d} such that 0.1 μs<p_{d}<5000 μs and 30 mA<pₕ<500 mA. The selection of the driving current may be further restricted due to thermal conditions. The pulse duration may be in a range having a lower limit of 0.1 μs, preferably 0.5 μs, more preferably 1 μs still more preferably 2 μs and an upper limit of 5000 μs, preferably 1000 μs, more preferably 500 μs, still more preferably 100 μs and the pulse height pₕ being selected larger than 30 mA, preferably larger than 75 mA, more preferably larger than 100 mA. Said tuning may furthermore comprise driving during at least one second time period t₂ the multi-mode broad area microlaser with an electric driving current selected as to obtain a spatial substantially more coherent light beam from said multi-mode broad area micro-laser. With substantially more coherent light it is meant that the coherence area may be 10% larger, preferably 20% larger, more preferably 50% larger, even more preferably 75% larger, still more preferably 100% larger than the coherence area of the illumination beam obtained for driving during the at least one first time period t₁. Said driving during said at least one first time period t₁ and driving during said at least one second time period t₂ may be used for transmitting signals. Said light output of the beam may be used for varying a resolution of a measurement.

The invention furthermore relates to a multi-mode broad area micro-laser, comprising a driver for driving said micro-laser with an electric driving current selected so as to obtain a reduced degree of spatial coherence in the far field plane transverse to said light beam from said multi-mode broad area micro-laser. With a reduced degree of spatial coherence it is meant that the light beam is not completely coherent over its transverse profile. The degree of coherence thereby is determined as the visibility V of the fringes of a two light beam interference test. A reduced degree of spatial coherence may mean that the coherence area of the beam is less than its aperture area. A reduced degree of spatial coherence of an illumination beam thus may be defined as an illumination beam having a coherence area smaller than the aperture area, more preferably smaller than one quarter the aperture area, even more preferably smaller than one tenth of the aperture area, still more preferably smaller than one hundredth of the aperture area, having as lower limit, where the microlaser becomes indistinguishable from an incoherent light source. Said driving current I(t) may be such that the change of resonant wavelength as a function of time t fulfils

$$\vert \frac{d }{d t} λ ( I ( t ) ) \vert > \frac{1}{10} \frac{pm}{µs}$$

and the driving time t fulfils t>20 ns. Driving time t herein represents the time of actual driving, such as e.g. a pulse duration for a pulsed driving current. Said driving current I(t) may be a rectangular current pulse and may have a pulse height pₕ and a pulse duration p_{d} such that 0.1 μs<p_{d}<5000 μs and 30 mA<p_{h<500} mA. The selection of the driving current may be further restricted due to thermal conditions. The pulse duration may be in a range having a lower limit of 0.1 μs, preferably 0.5 μs, more preferably 1 μps still more preferably 2 μs and an upper limit of 5000 μs, preferably 1000 μs, more preferably 500 μs, still more preferably 100 μs and the pulse height pₕ being selected larger than 30 mA, preferably larger than 75 mA, more preferably larger than 100 mA.

The invention also relates to a driver for a multi-mode broad area micro-laser, comprising means for driving said micro-laser with an electric driving current selected as to obtain a reduced degree of spatial coherence in the far field plane transverse to said light beam from said multi-mode broad area micro-laser. With a reduced degree of spatial coherence it is meant that the light beam is not completely coherent over its transverse profile.

It is an advantage of embodiments of the present invention that the degree of spatial coherence and the transverse beam profile corresponding therewith can be selected such that the light output beam has a Gaussian or Gaussian-like transverse profile in far-field.

It is also an advantage of embodiments of the present invention that the degree of spatial coherence or, corresponding therewith, the transverse beam profile can be changed by modulating the driving current.

It is furthermore an advantage of embodiments of the present invention that a specific degree of spatial coherence or, corresponding therewith, the transverse beam profile can be selected which is adapted to requirements of specific applications.

It is also an advantage of embodiments of the present invention that the degree of spatial coherence or, corresponding therewith, the transverse beam profile can be described and consequently, that specific spatial coherence states and transverse far field beam profiles can theoretically be selected.

It is furthermore an advantage that the object and advantages described above can be obtained for a multi-mode broad-area microlaser allowing to reach a significantly high amount of power, such as e.g. a multi-mode VCSEL. The teachings of the present invention permit the design of improved methods for driving broad-area micro-lasers, such as e.g. multi-mode VCSELs.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable output power and beam profile of devices of this nature.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 is a simplified cross-sectional view of a typical structure of an oxide confined conventional VCSEL as known from the prior art.

FIG. 2 is a graph of the intensity versus the distance of a transverse cut through the far field of a light beam from a broad-area VCSEL operated with a driving current consisting of square pulses with a large pulse height pₕ, as obtained in embodiments 1 to 4 of the present invention.

FIG. 3 is a graph of the contrast between fringes in a Young's interference experiment using a broad-area VCSEL driven according to a method as described in the first, third or fourth embodiment of the present invention, as function of the pulse duration p_{d}.

FIG. 4 is a graph of the contrast between fringes in a Young's interference experiment using a broad-area VCSEL driven according to a method as described in the first, third or fourth embodiment of the present invention, as function of the pulse height pₕ.

FIG. 5 is a density plot of the contrast between fringes in a Young's interference experiment using a broad-area VCSEL driven according to a method as described in the first, third or fourth embodiment of the present invention, as a function of the pulse height pₕ and the pulse duration p_{d}.

FIG. 6 is a rectangular pulsed driving current with a pulse height pₕ and a pulse duration p_{d} as can be used in a method according to the fourth embodiment of the present invention.

FIG. 7 is a graph of the dissipated power as a function of the applied current, for a broad-area VCSEL driven according to a method as described in the fourth embodiment of the present invention

FIG. 8a and FIG. 8b is a near-field respectively far-field view of a light beam from a broad-area VCSEL operated in continuous wave mode, as known from the prior art.

FIG. 9a and FIG. 9b is a near-field respectively far-field view of a light beam from a broad-area VCSEL operated in pulsed mode with a limited pulse height pₕ, as obtained in the embodiments of the present invention.

FIG. 10a and FIG. 10b a near-field respectively far-field view of a light beam from a broad-area VCSEL operated in pulsed mode with a large pulse height pₕ, as obtained in the embodiments of the present invention.

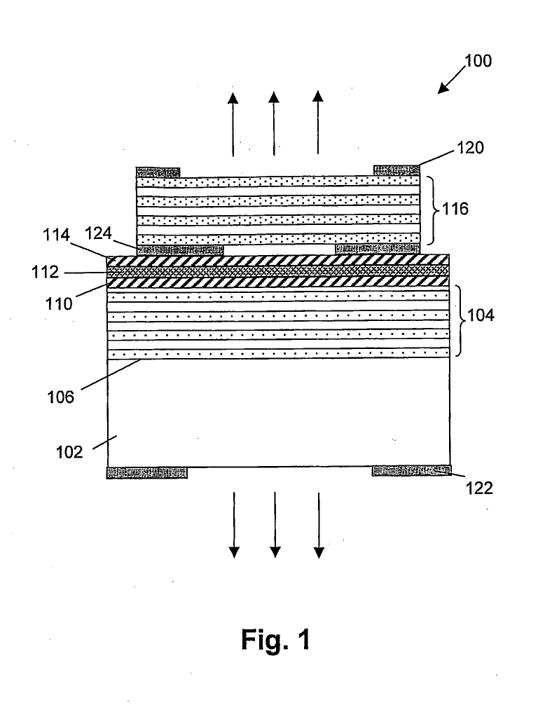

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In the present invention, the embodiments will be described for multi-mode VCSELs. However the present invention may be applied to any multi-mode broad area micro-laser.

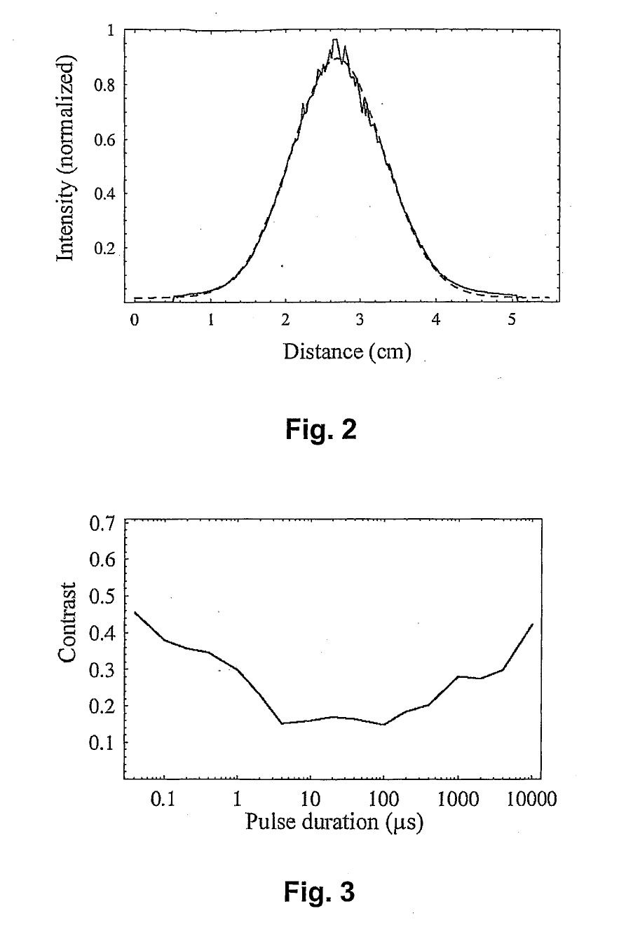

A first embodiment of the present invention, describes a multi-mode VCSEL and a method for driving the multi-mode VCSEL. The method for driving the multi-mode VCSEL and the multi-mode VCSEL adapted to be driven accordingly, allows to obtain a Gaussian far-field pattern for the multi-mode VCSEL, without the need for additional active or passive intra- or extra cavity elements. The method comprises modulating the electric driving current sent through a multi-mode VCSEL in such a way that a significant reduction of the spatial coherence in the light beam of the multi-mode VCSEL occurs. With significant reduction of the spatial coherence in the light beam of the multi-mode VCSEL, it is meant that the light beam is not completely coherent over its transverse profile, or in other words that the illumination beam has a coherence area smaller than the aperture area, more preferably smaller than one quarter of the aperture area, even more preferably smaller than one tenth of the aperture area, still more preferably smaller than one hundredth of the aperture area, having as lower limit, where the microlaser becomes indistinguishable from an incoherent light source. The coherence area thereby is defined as the area of the beam cross-section wherein coherent light occurs, well defined e.g. by Mandel and Wolf in “Optical Coherence and Quantum Optics” Wolf (Cambridge University Press 1995). Coherent light thereby is light wherein the degree of coherence exceeds 0.88. Light at two points within the transverse profile is considered to be partially coherent if the degree of coherence is less than 0.88 but more than nearly zero. Light at two points within the transverse profile is considered to be incoherent if its degree of coherence is nearly zero or zero. The degree of coherence thereby is determined as the visibility V of the fringes of a two light beam interference test. This visibility is defined as (Iₘₐₓ−Iₘᵢₙ)/(Iₘₐₓ+Iₘᵢₙ) wherein Iₘₐₓ equals the intensity at a maximum of the interference pattern and Iₘᵢₙ equals the intensity at a minimum of the interference pattern. The present invention also includes a driver for a multi-mode VCSEL modulating the electric driving current sent through the multi-mode VCSEL such that a significant reduction of the spatial coherence transverse in the light beam of the multi-mode VCSEL occurs. The modulation or the selection thereof may be done from at least one set of allowable driving conditions for which a significant reduction of the spatial coherence in the light beam of the multi-mode VCSEL occurs. Obtaining such a set can be e.g. performed based on experimental results or on theoretical considerations, e.g. based on an appropriate model. The way of obtaining such a set of allowable driving conditions is not considered to be limiting for the present invention. Furthermore, the at least one set of driving conditions may be predetermined for a wide range of multi-mode VCSELs such that obtaining allowable driving conditions is restricted to looking up these previously determined conditions, or they may be determined the moment the method is applied. An advantage of the spatial decoherence in a cross-section transverse the light beam is the formation of an unexpected Gaussian far-field intensity distribution. By way of example, the latter is illustrated for an oxide-confined multi-mode VCSEL emitting a multi-mode beam around λ₀=840 nm in FIG. 2, showing a transverse cut through the far field of the pulsed device. The solid line corresponds to the measured results, the dashed line corresponds with a Gaussian fit. The full far field opening is 22 degrees. It can be seen that in the far-field an advantageous Gaussian intensity distribution is obtained. This Gaussian profile allows use of the multimode VCSEL in a number of applications where a Gaussian beam profile is required. It is furthermore advantageous that the multi-mode VCSELs thereby allow to obtain a high optical output power. For 50 micrometer aperture devices, the maximal CW output power typically is about 40 mW when driven at a current of 80 mA. The main limiting factors are thermal roll-over as described by Nakwaski in Opt. Quantum Electron. 28 (1996)335 and electron escape from the quantum well. The peak output power is increased by pulsing—with a low duty cycle—the current sent through the device, as in that case the heat has time to dissipate. Maximal pulse powers—limited by the experimental setup—of up to 200 mW at a duty cycle of up to 10% are measured. It is to be noted that the driving conditions and the VCSEL used in the above example is only given for illustration purposes and that the invention is not limited thereto. The driving conditions may comprise any type of driving current, i.e. for example a pulsed rectangular, triangular or a sinusoidal current, allowing a reduction of the spatial coherence transverse in the light beam of the multi-mode VCSEL. Although the example illustrated in FIG. 2 is obtained for an oxide-confined multi-mode VCSEL emitting a multi-mode beam around λ₀=840 nm, the invention is not limited thereto but can be applied to any type of VCSEL wherein a reduction of the spatial coherence transverse in the light beam of the multi-mode VCSEL may be obtained.

In a second embodiment, the invention relates to a broad area VCSEL, a driver and a method of driving it according to the first embodiment, wherein the selection of the modulation of the electric driving current I(t) is based on modulation of the electric driving current I(t) such that the current induced chirp C(t) lies within specific boundary conditions. The thermal chirp C(t) is defined as the shift of the resonance wavelength λ as a function of the temperature change due to heating of the driven VCSEL. These boundary conditions define a set of driving conditions for the driving current I(t), used for driving the VCSEL, allowing reduction of the degree of spatial coherence to occur. The current I(t) sent through the device should be modulated in time t such that the resulting change of the resonance wavelength λ of the microlaser fulfils the following condition

$$C ( t ) = \vert \frac{d }{d t} λ ( I ( t ) ) \vert > \frac{1}{10} \frac{pm}{µs} \qquad [ 1 ]$$

where the Gaussian far field will be developed after

t>20 ns. [2]

Preferably the Gaussian far field may be developed after t>100 ns, more preferably after t>500 ns. Restricting the driving current conditions according to equation [1] and [2] allows to obtain a reduced degree of spatial coherence transverse the light beam and leads to the formation of an unexpected Gaussian far-field intensity distribution transverse the light beam. A physical explanation for the effect obtained using a driving current within the boundary conditions determined by equation [1] and equation [2] is unexpected as it cannot be derived from the known models used for describing pulsed multi-mode VCSELs. Without being limited by theory, a possible explanation is based on an intuitive picture of a VCSEL as a waveguide and the fact that reduction of the degree of spatial coherence is correlated to the disappearance of modal structure in the far field. When a laser starts emitting, the transient time for new modal patterns to be reached is determined by the geometry of the device. The current induced chirp C(t) destabilises the system and when the driving time t is large enough, e.g. t>20 ns, the initial modal pattern is lost. In continuous wave mode the system is stable and therefore, once a modal pattern is established, each stimulated photon is identical to the stimulating photon and hence should not be counted as a newly emitted one, as described by Peeters et al. in IEEE/IEOS topical meeting on VCSELs and microcavities, (San Diego, USA) (1999) p 51-52. This is not the case in pulsed mode. In order to have a stable modal pattern in a pulsed mode VCSEL, in which case the transient time is much longer than the photon lifetime, the change in wavelength during the transient time should be less than the linewidth of the laser to allow for photon recycling and the appearance of global modes. But if the change in wavelength during the said transient time is larger than the linewidth of the laser, which is the case when the condition of equation [1] is fulfilled, global modes are no longer supported. In the latter case, the VCSEL is described as a quasi-homogeneous Shell model source, also called Collet-Wolf source. The source thereby has a specific degree of spatial coherence, which in fact is the determining factor for the far-field intensity pattern. Using such a description may allow to determine an allowable set of boundary conditions for the driving current, such that the far-field intensity has a preferred profile.

In a third embodiment, the invention relates to a broad area VCSEL, a corresponding driver and a method for driving a VCSEL as described in the first embodiment, wherein the boundaries for the driving conditions are determined using an experimental procedure. This may e.g. be used when the specific device parameters are not sufficiently well known or protected by trade secret and cannot be divulged. From the contrast of fringes in an interference pattern of a Young's experiment for a driven VCSEL, the driving conditions can be determined for which a sufficient reduction of the degree of spatial coherence can be obtained. In practice, if by way of example, the method is applied for a VCSEL with unknown parameters, one uses two slits or more preferably two pinholes, with a separation of at least the order of magnitude of the device diameter, which can be determined by a microscope. The pinholes or slits will be henceforth called an interference mask. The size of the pinholes or slits is less important and a guide to suitable values can be found in e.g. John Goodman, “Introduction to Fourier Optics”, McGraw-Hill, New York. For different fixed driving conditions, the contrast “Co” can be determined between the maximum intensity “max” and the intensity minimum “min” of the interference pattern formed in the far field of the interference mask during the pulse. The contrast thereby is defined as

$$Co = \frac{{I}_{max} - {I}_{min}}{{I}_{max} + {I}_{min}} \qquad [ 3 ]$$

The condition wherein the VCSEL should be, in order to obtain a sufficient reduction of the degree of spatial coherence are determined by looking at the parameter range where for at least part of the light in the illumination beam after passing the aperture the contrast is smaller than a predetermined value, such as e.g. smaller than 0.88, smaller than 0.5, smaller than 0.3, smaller than 0.2. In other words, the contrast then fulfils e.g. the condition

Co<0.3 [4]

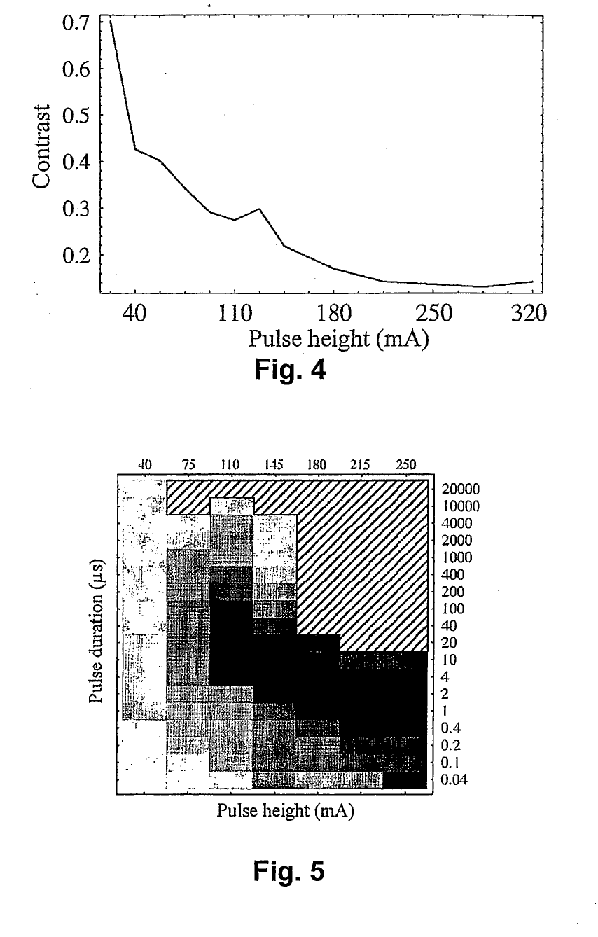

for at least part of the illumination beam falling within the aperture of the system.
By way of example, the method is illustrated for a pulsed VCSEL driven with a square pulse with pulse duration p_{d} and pulse height pₕ. Recording the value of Co for different pulse lengths p_{d}, and repeating the measurements for different pulse heights pₕ results in the graphs shown in FIG. 3 and FIG. 4 and allows to obtain a density plot as shown in FIG. 5. In this exemplary illustration, the VCSEL thereby was pulsed with a duty cycle of 2%. In the density plot, a high contrast, i.e. Co=0.7, is indicated with white, whereas a low contrast, i.e. Co=0.04, is indicated with black. The dashed area corresponds to points beyond the thermal roll-over of the laser. For a general driving pulse, the ranges for the average pulse duration and the average pulse height depend on the geometry and growth of the device. This is mainly determined by the heating of the device. An estimate of an allowable pulse duration of at least 1 μs and an allowable pulse height of at least 1/20 mA/μm² for most driving pulses may be used.

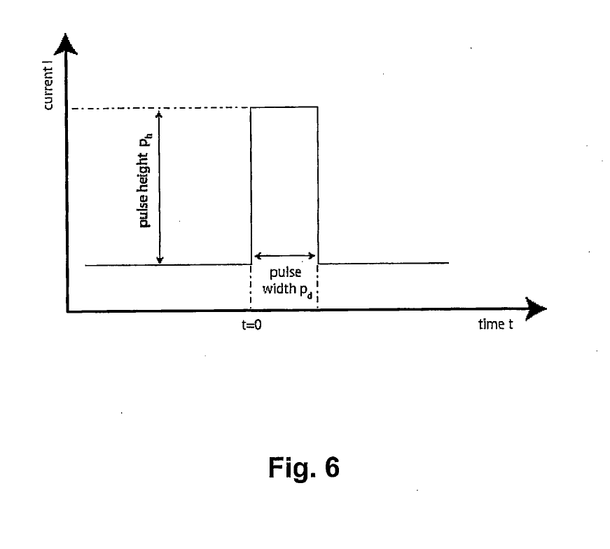

In a fourth embodiment, the invention relates to a broad area VCSEL, a corresponding driver and a method for driving a broad area VCSEL as described in any of the previous embodiments, wherein the electric driving current I(t) sent through the multi-mode VCSEL is a rectangular pulse driving current with a pulse height pₕ and a pulse duration p_{d} as shown in FIG. 6. The rectangular pulse driving current is selected such that a reduction of the spatial coherence in the light beam of the multi-mode VCSEL occurs. The boundary conditions for the driving current allowing a sufficient reduction of the spatial coherence area, can for a rectangular pulse driving current be expressed as boundary conditions for the pulse height pₕ and the pulse duration p_{d}.

By way of example, a selection of driving conditions based on experimental results and a selection of driving conditions based on modelling results are determined for an oxide-confined multi-mode VCSEL driven by a rectangular pulsed driving current.

Based on experimental results for a series of Young's experiments, as described in more detail in the third embodiment, an allowable set of driving conditions is defined by the pulse duration being selected from a range with a lower limit of 0.1 μs, preferably 0.5 μs, more preferably 1 μs still more preferably 2 μs and an upper limit of 5000 μs, preferably 1000 μs, more preferably 500 μs, still more preferably 100 μs and the pulse height pₕ being selected larger than 30 mA, preferably larger than 75 mA, more preferably larger than 100 mA. A more optimised set of driving conditions can be obtained if one of the driving current parameters is selected and the remaining driving parameter is selected accordingly based on the equations

pₕ>60 mA

Pd−5.36 μs.exp(−0.032*Pₕ/mA)>0

Pd−7200 μs.exp(−0.026*Pₕ/mA)<0 [5]

determined from the experimental results shown in FIG. 5.

Alternatively, boundary conditions can be obtained, based on a model for the thermal chirp occurring in the device driven with a rectangular pulsed driving current, as discussed in the second embodiment. During the rectangular pulse, the microlaser cavity will heat up and due to thermal expansion and the thermo-optic effect, a thermal chirp will occur. Although a more precise description of the temperature rise in a VCSEL can be given, in this embodiment an exponential functional behaviour with the same timescale τ is used. The total wavelength shift starting from the beginning of the pulse at t=0 is then given by

λ(t)=Q(T_{f}−T₀)(1−e^{-t/τ})+λ₀ [6]

with the constant Q a pre-factor grouping all the thermal effects in the device and T₀ being the initial temperature at the beginning of the pulse and T_{f} being temperature that would be reached in the steady state. Q can be calculated from

$$Q = \frac{2}{N} ( Δ {n}_{co} L + \frac{{λ}_{0}}{2 π} {a}_{L} ) \qquad [ 7 ]$$

with the thermo-optical coefficient Δnₜ₀, the thermal expansion coefficient a_{L}, the cavity wavelength λ₀ and the longitudinal order of the resonance N. As an example, Δnₜₒ is equal to 4.5 10⁻⁵/K for a GaAs device, as determined in “Data in Science and Technology: Semiconductors, Group IV Elements and II-V Compounds” (Springer-Verlag, 1991) and an order of magnitude bigger than a_{L}=5 10⁻⁶/K. The chirp C(t) is then

$$C ( t ) = \vert \frac{d λ ( t )}{d t} \vert = Q ( {T}_{f} - {T}_{0} ) \frac{- 1}{τ} ( {e}^{- t / τ} ) = Δ {λ}_{tot} \frac{- 1}{τ} {e}^{- t / τ} \qquad [ 8 ]$$

In the present invention, where a reduction of the degree of spatial coherence is to be obtained, or in other words where the VCSEL should be in a continuously non-global state, the following equation should be fulfilled

$$\frac{Δ Λ}{2 Δ {t}_{min}} < C ( t ) \qquad [ 9 ]$$

with ΔΛ being the linewidth of the laser and Δtₘᵢₙ being the transient time for new modal patterns to be obtained. The transient time Δtₘᵢₙ can for example be determined from the waveguide properties of the microlaser. An explicit calculation of the limits for the pulse duration pₕ can be derived e.g. for a 50 μm diameter VCSEL which is oxide confined, based on some additional assumptions. If the VCSEL is considered as a waveguide, the transient length after which a modal pattern is established can be defined as

$$Δ z = \frac{Πρ}{{θ}_{c}} {e}^{V / 2} \qquad [ 10 ]$$

where ρ is the core radius, θ_{c} gives the complement of the critical angle for the waveguide inside the device and V is the waveguide parameter or frequency for the device. The latter two can be calculated in several ways, depending on the desired modelling accuracy, as discussed by Snyder and Love in “Optical Waveguide Theory” (Kluwer Academic Publishers, 1984) p 734. The pre-factor Π depends on the kind of waveguide: for a step waveguide, Π=1, for a parabolic one, Π=π. The equivalent transient time Δtₘᵢₙ can be defined (with n_{co} the average cavity index)

$$Δ {t}_{min} ≅ \frac{{n}_{co} Δ z}{c} \qquad [ 11 ]$$

which leads, for a 50 μm diameter device with a waveguide index step due to the oxide aperture of Δn=5×10⁻³, to a lower bound on the transient time

Δtₘᵢₙ>20 ns [12]

In the present case, n_{co}=3.5, Π=π and rho=50 micrometer. A lower bound for the pulse duration p_{d} is given by this transient time of the built-in waveguide. More accurate numbers can be obtained by modal calculations for a specific device and taking into account modal coupling effects. Essentially, equation [9] expresses that the wavelength change exceeds the linewidth in a time smaller than the transient time. It thereby is to be noted that the chirp is a function of the pulse duration p_{d} and the pulse height pₕ. Combining equation [9] with [8] allows to determine the maximum allowable pulse duration. The latter results in

$${v}_{min} ≡ \frac{Δ Λ}{2 Δ {t}_{min}} < Δ {λ}_{tot} \frac{1}{τ} {e}^{- t / τ} \qquad [ 13 ]$$

and this will no longer be valid past

$$t ≅ - τ {log}_{e} \frac{τ {v}_{min}}{Δ {λ}_{tot}} \qquad [ 14 ]$$

Taking as an example a laser linewidth of 10 MHz, it can be found that (as the built-in waveguide determines the minimal transient time) in the 50 μm devices, the limit is set by

$${v}_{min} = \frac{1 pm}{1 µs} \qquad [ 15 ]$$

This means for typical total wavelength change of the order of 1 nm, the time at which this equation is no longer satisfied is

$$t ≅ - τ {log}_{e} \frac{τ}{Δ {λ}_{tot} {10}^{6} s \text{/} m} \qquad [ 16 ]$$

which, if the total wavelength change is in the order a few nm and τ of a few μs, is

$$t ≅ τ ( 13 - {log}_{e} \frac{τ}{Δ {λ}_{tot}} ) \approx 13 τ \qquad [ 17 ]$$

Hence, for these devices the modal pattern starts to emerge again for pulses of the order of 10 μs, in good agreement with experimental results. We can thus use this number as a suitable maximum pulse duration p_{d}. Additionally, for stronger waveguides, this will not change a lot, as the effect of the exponentially growing V is contained by the logarithm. The latter will be slightly influenced if a power law temperature dependence is assumed. The exact value nevertheless has a minor influence on the boundary.

One can now determine the pulse height pₕ required by starting from the thermal resistance of the VCSEL given by

$${R}_{thermal} = \frac{1}{4 {λ}_{c} ρ} \qquad [ 18 ]$$

where ρ is the radius and λ_{c} is a constant for the device geometry. For the devices under test, the obtained thermal resistance is 0.25K/mW, from λ_{c}=40 W/Km. The above results can be linked to the dissipated power in the VCSEL. The current-voltage V(I) and output power P(I) characteristics give us the dissipated thermal power Pₜₕₑᵣₘₐₗ(I)=V(I)·I−P(I) which needs to be multiplied with the thermal resistance to find the temperature rise T

T=Pₜₕₑᵣₘₐₗ·Rₜₕₑᵣₘₐₗ [19]

In the case of the devices used as an example, the voltage-current characteristic has been experimentally determined and is well approximated by

V(I)=1.33V+2.5V\sqrt{I}+3VI [20]

with the current I being expressed in ampere. Additionally, the emitted power P is well approximated by

$$P ( I ) = 0.7 \frac{W}{A} ( I - 0.015 A ) \qquad [ 21 ]$$

Hence the dissipated thermal power is given by

Pₜₕₑᵣₘₐₗ(I)=V(I)I−P(I)≅0.63VI+2.5VI^{3/2}+3VI² [22]

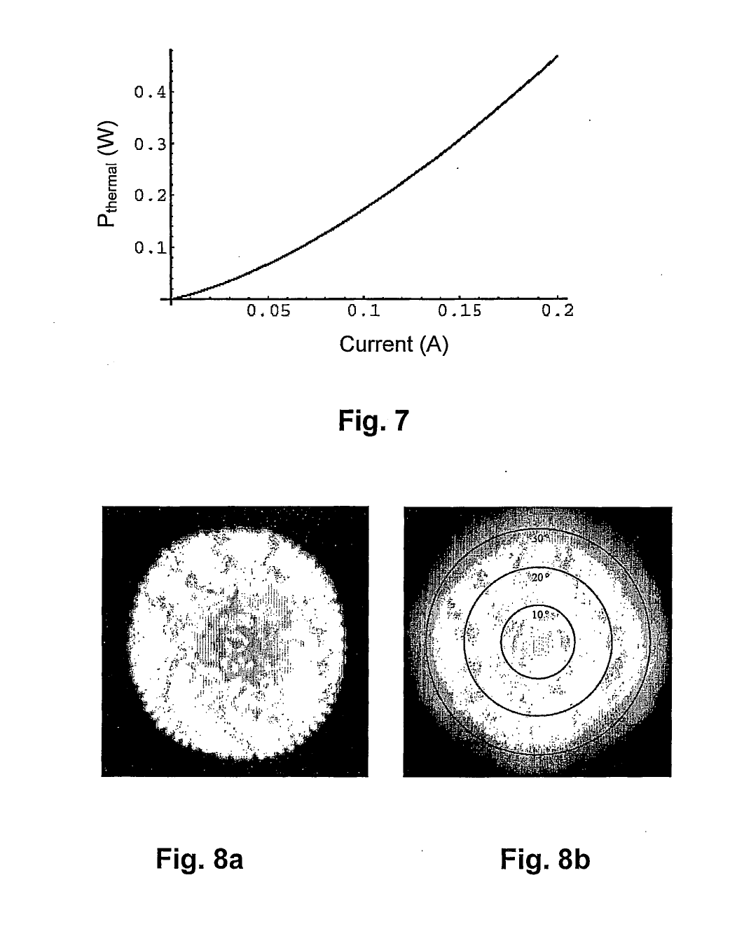

as shown in FIG. 7. For the devices used as an non-limiting example, the temperature rise corresponds to 25K at the typical pulse heights of about pₕ=75 mA with a corresponding power of 100 mW.

Combining the calculated temperature rise using the thermo-optical coefficient, one can now determine the total index shift and the chirp. For example, in the 50 micrometer diameter GaAs devices, the calculated total index shift for an injection current of 100 mW is 0.11×10⁻². In a cavity with an optical length of L=850 nm, this corresponds to a wavelength change of about 1 nm, which is in good agreement with the experimental values. This supports the statement that the values used in expression [14] for determining required the pulse duration and pulse height boundaries result in valuable results.

The model typically may be used either to predict the different ranges for the driving parameters such that a Gaussian-like far-field beam is obtained or to confirm obtained corresponding experimental results. In other words, in the present embodiment, the selection of the appropriate driving parameters may be based on a model based prediction of the light output of the multimode VCSEL. Alternatively, instead of using the created power to check the validity of the results, the experimentally obtained maximum chirp that occurs can also be used.

In conclusion, it can be seen that for an exemplary VCSEL, boundaries based on experimental results and boundaries based on model results are in good agreement with each other, indicating that either or both techniques can be used for determining boundary conditions for the driving current for VCSELs.

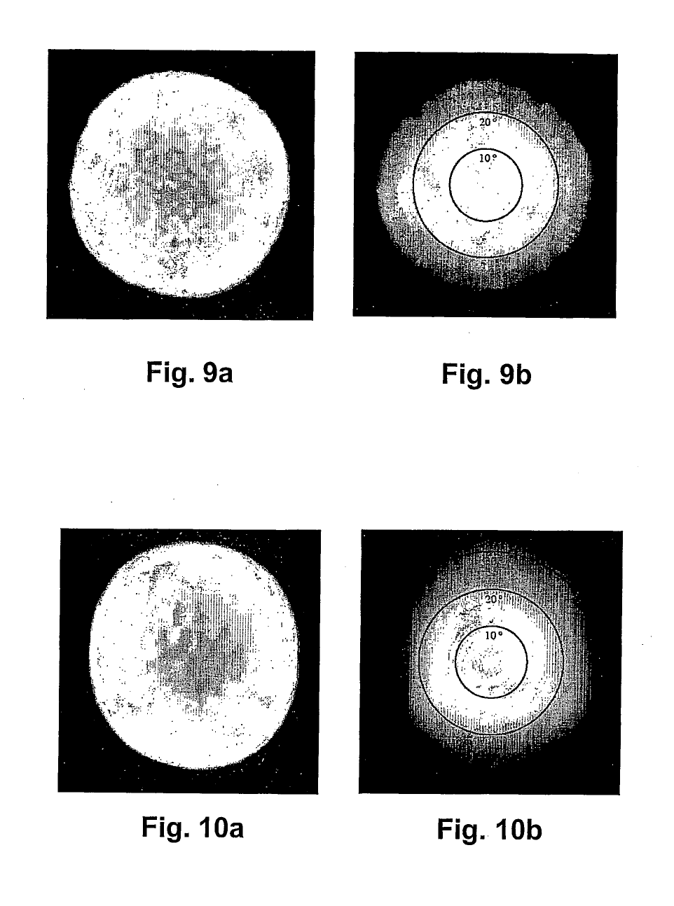

By way of example, the advantages of adjusting the driving conditions for VCSELs according to the embodiments of the present invention are illustrated in FIG. 8a to FIG. 10b, illustrating the near and the far field of VCSELs driven under different conditions. By way of example—the invention not being limited thereto—measurement results are shown for 50 micrometer aperture VCSELs under different driving conditions. The VCSELs measured are native oxide confined and emit a multimode beam around λ₀=840 nm. FIG. 8a and FIG. 8b illustrate the near field, respectively the far field of a VCSEL light beam for a VCSEL operating in continuous wave mode. In the current example, the near-field and far-field are indicated for a current injection of 39 mA. One can see that in continuous wave operation, the near field as shown in FIG. 8a is dominated by a ring structure. The ring structure belongs to a superposition of several high order Laguerre-Gauss daisy modes. FIG. 9a and FIG. 9b illustrate the near and the far field image of a VCSEL light beam for a VCSEL operating in pulsed mode, with a pulse height pₕ of 40 mA, a pulse duration of 1 μs and a duty cycle of 2 percent. It can be seen in FIG. 9a that the near field is still dominated by a ring structure as in the CW case, albeit slightly more blurred, but the far field, shown in FIG. 9b, has developed a maximum in the centre. Some remnants of the CW modal structure can still be seen at large angles. FIG. 10a and FIG. 10b illustrate the near and far field images of a VCSEL light beam for a VCSEL operating in pulsed mode at a pulse height pₕ of 320 mA, a pulse duration p_{d} of 1 μs and a duty cycle of 2 percent. It can be seen that the near field, shown in FIG. 10a, suffers only slightly more blurring of the ring, but the far field, as shown in FIG. 10b, has changed into a fully Gaussian profile with a full opening angle of 22 degrees, i.e. corresponding with the points where the intensity has dropped to 1/e² of the central intensity. The divergence of the beam does not match with what would be expected from the aperture size nor from a Laguerre-Gauss superposition.

A fifth embodiment relates to a method for driving the broad area micro-laser, such as e.g. a multimode VCSEL, whereby the method comprises the same steps and features as any of the previous lasers or methods, but whereby additionally, the degree of spatial coherence is tuned within, or in and out of, the range of allowable driving conditions. For a square pulsed driving current, this may e.g. be done by changing the pulse duration p_{d} and/or pulse height pₕ within these allowable driving conditions. By tuning the driving parameters within the range of allowable driving conditions, the far-field output of the light beam is tuned and an optimum Gaussian-like beam profile can be obtained and maintained, e.g. during performed experiments. In other words, the spatial coherence is tuned by tuning the driving parameters. An illustration of the parameters that can be used for tuning if for the example a pulsed square driving voltage is shown in FIG. 3 and FIG. 4 illustrating the influence of the pulse height pₕ and the pulse duration p_{d} on the degree of spatial coherence. It is to be noted that tuning is not restricted to tuning to obtain a Gaussian-like beam profile, but that, depending on the type of experiment to be performed, other beam profiles also may be preferred. Alternative to tuning within the range of allowable driving conditions for obtaining a reduced degree of spatial coherence, tuning may be done at some moments within the range of allowable driving conditions for obtaining a reduced degree of spatial coherence and at some moments outside the range of allowable driving conditions, whereby the far field transverse intensity distribution may be used to transmit information.

The invention furthermore also relates to applying any of the above described methods for specific experiments, such as experiments which need an increased depth of focus, microdensitometry measurements, line width measurements, lithography applications, laser range finders or applications where a change in resolution is required. Light sources with a high degree of spatial coherence sometimes have detrimental effects as they often give rise to speckled images, which make it difficult to obtain good resolution, as described in Mandel and Wolf (Cambridge University Press 1995). The latter is avoided when the methods as described in the above embodiments are applied. In this way, the drivers and driving methods of the present invention result in an improvement of resolution. The methods described above thus allow to obtain light beams with a reduced degree of spatial coherence, which are highly directional and have a more homogeneous light spreading over the cross-section of the beam than multi-mode VCSELs driven otherwise. The high directionality of the beams also may be advantageously used. The methods described above also allow e.g. to increase the depth of focus. The methods furthermore can be applied for beam steering such that an optimal beam can be selected for each type of experiment or measurement. Modulation of the driving conditions for the VCSEL also could be used for selecting a different resolution of a system, as the resolution typically also is determined by the far-field beam profile that is used. Changing the driving conditions and thus the far-field transversal beam profile, thus will result in different spreading of the light intensity over the beam profile and thus in a different resolution obtained with a measurement system using the light beam.

It is to be noted that in the embodiments of the present application, a Gaussian far-field beam profile similar to that of a fully coherent single fundamental transverse mode, but no longer fully spatially coherent, is obtained from a broad-area multimode laser without the need for any additional active or passive intra- or extra cavity elements. In other words the advantageous beam qualities can be obtained in a monolithic system. In prior art, this appearance only has been obtained for lasers with additional active or passive intra- or extra cavity elements.

Other arrangements of the multi-mode broad area microlasers and the method for driving multi-mode broad area microlasers embodying the invention will be obvious for those skilled in the art. It is to be understood that although preferred embodiments, specific methods and examples of VCSELs and driving methods for VCSELs with specific constructions and configurations, as well as materials, have been discussed herein, the invention is not limited thereto and various changes or modifications of the VCSELs and the driving methods may be made without departing from the scope and spirit of this invention.

1-22. (canceled)

23. A method for driving a multi-mode broad area micro-laser, the method comprising,
driving said micro-laser with an electric driving current, said driving current selected as to obtain a reduced degree of spatial coherence in the far field plane transverse to said light beam from said multi-mode broad area micro-laser, whereby the light beam is not completely coherent over its transverse profile and no modal emission pattern occurs in the far field plane.

24. A method for driving according to claim 23, wherein not completely coherent over its transverse profile is the coherence area being smaller than the aperture area, preferably smaller than one quarter of the aperture area, more preferably smaller than one tenth of the aperture area, even more preferably smaller than one hundredth of the aperture area.

25. A method for driving according to claim 23, the micro-laser emitting at a resonant wavelength λ, wherein said driving current I(t) is selected such that the change of resonant wavelength as a function of time t fulfils
$$\vert \frac{d}{d t} λ ( I ( t ) ) \vert > \frac{1}{10} \frac{pm}{µs}$$
and the driving time t fulfils
t>20 ns.

26. A method for driving according to claim 23, wherein the driving current is a rectangular current pulse having a pulse height pₕ and
a pulse duration p_{d} such that
$$\vert \frac{d}{d t} λ ( I ( {p}_{h} , {p}_{d} ) ) \vert > \frac{1}{10} \frac{pm}{µs}$$
$$and$$
$${p}_{d} > 20 ns .$$

27. A method according to claim 25, wherein the driving current is a rectangular current pulse having a pulse height pₕ and
a pulse duration p_{d} such that
$$\vert \frac{d}{d t} λ ( I ( {p}_{h} , {p}_{d} ) ) \vert > \frac{1}{10} \frac{pm}{µs}$$
$$and$$
$${p}_{d} > 20 ns .$$

28. A method according to claim 26, wherein said pulse duration p_{d} and said pulse height pₕ are selected such that
0.1 μs<p_{d}<5000 μs and 30 mA<pₕ<500 mA.

29. A method according to claim 27, wherein said pulse duration P_{d} and said pulse height pₕ are selected such that
0.1 μs<p_{d}<5000 μs and 30 mA<pₕ<500 mA.

30. A method according to claim 23, wherein said driving current is selected such that a contrast Co between interference fringes in a Young's experiment for at least part of the light in a far field of said light beam is smaller than a predetermined value A, such that Co<A.

31. A method according to claim 30, wherein said predetermined value A is 0.88, preferably 0.5, more preferably 0.3, even more preferably 0.2.

32. A method according to claim 23, wherein said multi-mode broad area micro-laser is a multi-mode vertical cavity side-emitting laser.

33. A method according to claim 23, wherein said multi-mode broad area micro-laser has an aperture with a characteristic diameter of more than 10 μm.

34. A method according to claim 23, wherein said light output of said light beam having a reduced degree of spatial coherence is used for any of microdensitometry, line width experiments, laser range finders or lithography applications.

35. A method for tuning a light beam of a multi-mode broad area micro-laser, the method comprising
driving during at least one first time period t₁ the multi-mode broad area microlaser with an electric driving current selected as to obtain a reduced degree of spatial coherence in the far field plane transverse to said light beam from said multi-mode broad area micro-laser, whereby the light beam is not completely coherent over its transverse profile and no modal emission pattern occurs in the far field plane, in order to adjust a light output of said spatial only partial coherent light beam.

36. A method according to claim 35, wherein said driving current I(t) is such that the change of resonant wavelength as a function of time t fulfils
$$\vert \frac{d}{d t} λ ( I ( t ) ) \vert > \frac{1}{10} \frac{pm}{µs}$$
and the driving time t fulfils
t>20 ns.

37. A method according to claim 35, wherein said driving current I(t) is a rectangular current pulse having a pulse height pₕ and
a pulse duration p_{d} such that
0.1 μs<p_{d}<5000 μs and 30 mA<p_{d}<500 mA.

38. A method according to claim 36, wherein said driving current I(t) is a rectangular current pulse having a pulse height pₕ and
a pulse duration p_{d} such that
0.1 μs<p_{d}<5000 μs and 30 mA<p_{d}<500 mA.

39. A method according to claim 35, wherein said tuning furthermore comprises
driving during at least one second time period t₂ the multi-mode broad area microlaser with an electric driving current selected as to obtain a spatial substantially more coherent light beam from said multi-mode broad area micro-laser.

40. A method according to claim 39, wherein driving during said at least one first time period t₁ and driving during said at least one second time period t₂ is used for transmitting signals.

41. A method according to claim 35, wherein the light output of the beam is used for varying a resolution of a measurement.

42. A multi-mode broad area micro-laser, comprising,
a driver driving said micro-laser with an electric driving current selected as to obtain a reduced degree of spatial coherence in the far field plane transverse to said light beam from said multi-mode broad area micro-laser, whereby the light beam is not completely coherent over its transverse profile and no modal emission pattern occurs in the far field plane.

43. A multi-mode broad area micro-laser according to claim 42, wherein said driving current I(t) is such that the change of resonant wavelength as a function of time t fulfils
$$\vert \frac{d}{d t} λ ( I ( t ) ) \vert > \frac{1}{10} \frac{pm}{µs}$$
and the driving time t fulfils
t>20 ns.

44. A multi-mode broad area micro-laser according to claim 42, wherein said driving current I(t) is a rectangular current pulse having a pulse height pₕ and
a pulse duration p_{d} such that
0.1 μs<p_{d}<5000 μs and 30 mA<pₕ<500 mA.

45. A multi-mode broad area micro-laser according to claim 43, wherein said driving current I(t) is a rectangular current pulse having a pulse height pₕ and
a pulse duration p_{d} such that
0.1 μs<p_{d}<5000 μs and 30 mA<pₕ<500 mA.

46. A driver for a multi-mode broad area micro-laser, comprising,
means for driving said micro-laser with an electric driving current selected as to obtain a reduced degree of spatial coherence in the far field plane transverse to said light beam from said multi-mode broad area micro-laser, whereby the light beam is not completely coherent over its transverse profile and no modal emission pattern occurs in the far field plane.
